(19) United States
(12) Patent Application Publication
(10) Pub. No.: US 2009/0091812 A1
(43) Pub. Date: Apr. 9, 2009

(54) QUANTUM COMPUTER AND QUANTUM COMPUTATION METHOD

(76) Inventors: Hayato GOTO, Kawasaki-shi (JP); Kouichi Ichimura, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/233,044

(22) Filed: Sep. 18, 2008

(30) Foreign Application Priority Data
Sep. 26, 2007 (JP) 2007-249651

(51) Int. Cl. G06E 3/00

(52) U.S. Cl. 359/107; 977/933

(57) ABSTRACT

A quantum computer includes physical systems, included in an optical resonator, having at least four energy states, and in which letting |0>, |1>, |3>, and |2> be the four energy states, an energy of |2> is higher than energies of |0>, |1>, and |3>, a transition frequency of a |0>−|2> transition is equal to the resonance frequency, and |0> and |1> express a quantum bit, a first source emitting light that resonates with the optical resonator, a second source irradiating specific physical systems of the physical systems with light that couples |3> and |2>, a light detector detecting a photon emitted from the optical resonator, and a controller controlling the first source to irradiate the optical resonator with light and controlling the light detector to perform light detection during irradiation of the light that couples |3> and |2> from the second source to the specific physical systems.

### CROSS-REFERENCE TO RELATED APPLICATIONS

This application is based upon and claims the benefit of priority from prior Japanese Patent Application No. 2007-249651, filed Sep. 26, 2007, the entire contents of which are incorporated herein by reference.

### BACKGROUND OF THE INVENTION

1. Field of the Invention

The present invention relates to a quantum computer which exploits coupling between an optical resonator and atoms.

2. Description of the Related Art

In recent years, studies about quantum computers have been extensively made. As an implementation method of a quantum computer, a method which prepares a plurality of physical systems each having three states in an optical resonator, and performs a two-quantum-bit gate by externally inputting photons that resonate with the optical resonator has been proposed (for example, see L.-M. Duan, B. Wang, and H. J. Kimble, Phys. Rev. A 72, 032333 [2005]). With this method, a two-quantum-bit gate called a controlled phase-flip gate can be implemented at a low error probability. The controlled phase-flip gate can configure an arbitrary quantum gate when it is combined with one-quantum-bit gates. In this sense, it suffices to configure only the controlled phase-flip gate as the two-quantum-bit gate.

However, in order to perform a more general two-quantum-bit gate, e.g., a general controlled unitary gate, the controlled phase-flip gate is required to be performed twice in many cases. As a result, the error probability of the controlled unitary gate becomes higher than the controlled phase-flip gate. On the other hand, if a controlled phase-shift gate can be implemented at the same error probability as the controlled phase-flip gate, since the number of operations required to perform the controlled unitary gate is only one, the controlled unitary gate can be implemented at a lower error probability. Therefore, it is desirable if the controlled phase-shift gate can be implemented at nearly the same error probability as the controlled phase-flip gate proposed by Duan et. al.

### BRIEF SUMMARY OF THE INVENTION

In accordance with an aspect of the invention, there is provided a quantum computer comprising: an optical resonator configured to have a resonance frequency; a plurality of physical systems, which are included in the optical resonator, configured to have at least four energy states, and in which letting |0>, |1>, |3>, and |2> be the four energy states, an energy of |2> is higher than energies of |0>, |1>, and |3>, a transition frequency of a |0>−|2> transition is equal to the resonance frequency, and |0> and |1> express a quantum bit; a first light source configured to emit first light that resonates with the optical resonator; a second light source configured to irradiate a plurality of specific physical systems of the physical systems with second light that couples |3> and |2>; a light detector configured to detect a photon emitted from the optical resonator; and a controller configured to control the first light source to irradiate the optical resonator with the first light and control the light detector to perform light detection during irradiation of the second light to the specific physical systems.

In accordance with another aspect of the invention, there is provided a quantum computer comprising: an optical resonator configured to have a resonance frequency; a plurality of physical systems, which are included in the optical resonator, configured to have at least six energy states, and in which letting |0>, |1>, |3>, |4>, |2>, and |5> be the six energy states, energies of |2> and |5> are higher than energies of |0>, |1>, |3>, and |4>, a transition frequency of a |4>−|2> transition is equal to the resonance frequency, light beams which resonate with |0>−|5>, |1>−|5>, |3>−|5>, and |4>−|5> transitions of respective physical systems do not resonate with all optical transitions of other physical systems, and |0> and |1> express a quantum bit; a first light source configured to emit first light that resonates with the optical resonator; a second light source configured to irradiate the physical systems with second light that couples |3> and |2>; a third light source configured to irradiate respective physical systems with third light that nearly resonates with the |0>−|5>, |1>−|5>, |3>−|5>, and |4>−|5> transitions; a light detector configured to detect a photon emitted from the optical resonator; and a controller configured to select a physical system as a target of the third light source, and to allow irradiation of the first light and light detection by the light detector during irradiation of the second light.

### BRIEF DESCRIPTION OF THE SEVERAL VIEWS OF THE DRAWING

FIG. 1 is a view showing a quantum circuit that shows a method of executing a general controlled unitary gate using a controlled phase-flip gate;

FIG. 2 is a view showing a quantum circuit that shows a method of executing a general controlled unitary gate using a controlled phase-shift gate;

FIG. 3 is a view showing a system used in a conventional method;

FIG. 4 is a view showing a system used in an embodiment;

FIG. 5 is a block diagram of a quantum computer according to the embodiment, which uses physical systems corresponding to FIG. 4;

FIG. 6 is a view showing state names set in the embodiment;

FIG. 7 is a view showing a ring resonator that implements a variable transmittance mirror;

FIG. 8 is a block diagram showing a part of the quantum computer shown in FIG. 5 when a dye laser is used in place of a single-photon generator;

FIG. 9 is a graph showing the calculation result of a phase shift θ of a controlled phase-shift gate by the quantum computer according to the embodiment;

FIG. 10 is a view showing a quantum circuit that shows a method of executing a general controlled unitary gate using a controlled phase-shift gate that performs a phase shift near π;

FIG. 11 is a graph showing the calculation result of a fidelity of a controlled phase-shift gate by the quantum computer according to the embodiment;

FIG. 12 is a graph showing the calculation result of a success probability of a controlled phase-shift gate by the quantum computer according to the embodiment;

FIG. 13 is a view showing a system used in the embodiment, which allows to individually operate quantum bits by the difference among the laser frequencies;

FIG. 14 is a block diagram of a quantum computer according to the embodiment, which uses physical systems corresponding to FIG. 13; and

FIG. 15 is a view showing state names set in the embodiment.

### DETAILED DESCRIPTION OF THE INVENTION

A quantum computer and quantum computation method according to an embodiment of the present invention will be described in detail hereinafter with reference to the accompanying drawings. In the embodiment to be described below, parts denoted by the same reference numerals make similar operations, and a repetitive description thereof will be avoided.

According to the quantum computer and quantum computation method of the embodiment, a controlled unitary gate can be executed at a lower error probability than the case of performing only a controlled phase-flip gate.

The reason why not only a controlled phase-flip gate but also a controlled phase-shift gate is preferably implemented will be described first. A controlled phase-flip gate is defined by:

a₀₀|0 [symbol] |0 [symbol] +a₀₁|0 [symbol] |1 [symbol] +a₁₀|1 [symbol] |0 [symbol] +a₁₁|1 [symbol] |1 [symbol] →a₀₀|0 [symbol] |0 [symbol] +a₀₁|0 [symbol] |1 [symbol] +a₁₀|1 [symbol] |0 [symbol] −a₁₁|1 [symbol] |1

[symbol]

On the other hand, a controlled phase-shift gate that shifts by only a phase θ is defined by:

a₀₀|0 [symbol] |0 [symbol] +a₀₁|0 [symbol] |1 [symbol] +a₁₀|1 [symbol] |0 [symbol] +a₁₁|1 [symbol] |1 [symbol] →a₀₀|0 [symbol] |0 [symbol] +a₀₁|0 [symbol] |1 [symbol] +a₁₀|1 [symbol] |0 [symbol] +e^{1θ}a₁₁|1 [symbol] |1

[symbol]

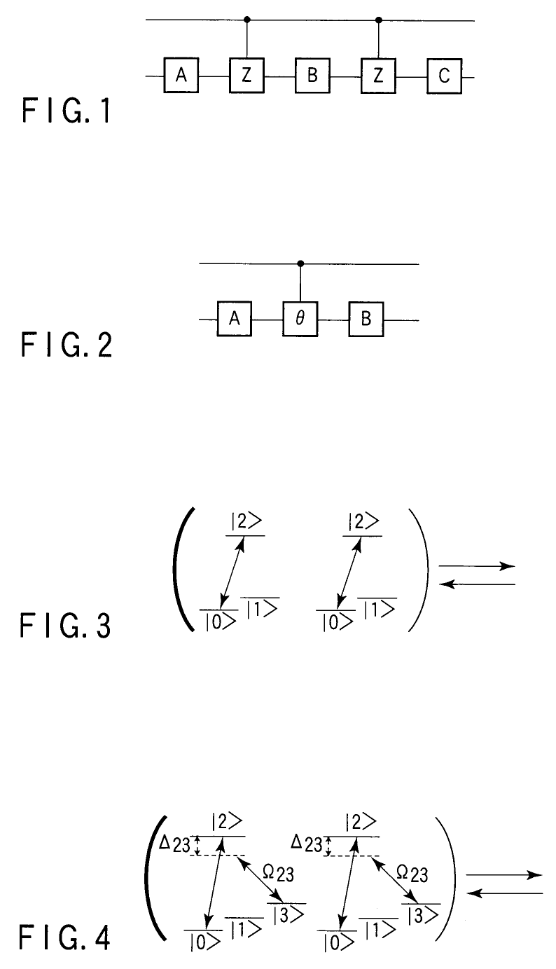

A controlled phase-shift gate which shifts a phase by π is the same as a controlled phase-flip gate. A general controlled unitary gate can be expressed using a controlled phase-flip gate, as shown in FIG. 1 (see M. A. Nielsen and I. L. Chuang, Quantum Computation and Quantum Information, [Cambridge Univ. Press, Cambridge, 2000]). In FIG. 1, A, B, and C represent appropriate one-quantum-bit gates. On the other hand, in consideration of the fact that the absolute value of an eigenvalue of a unitary matrix is 1, a general controlled unitary gate can be expressed using a controlled phase-shift gate, as shown in FIG. 2. From FIGS. 1 and 2, the number of two-quantum-bit gate operations required to perform the general controlled unitary gate is two if only the controlled phase-flip gate is used, and one if the controlled phase-shift gate is used. Hence, assuming that the error probability of each one-quantum-bit gate is sufficiently small, and the error probability of the controlled phase-shift gate is roughly the same as that of the controlled phase-flip gate, the controlled unitary gate can be implemented at a lower error probability when the controlled phase-shift gate is used than using only the controlled phase-flip gate.

A conventional implementation method of a controlled phase-flip gate and an implementation method of a controlled phase-shift gate according to this embodiment will be described below. A case will be examined below wherein there are only two quantum bits for a while, for the sake of simplicity. Assume that a one-quantum-bit gate can be freely performed. A method of performing a gate operation for a specific quantum bit when there are three or more quantum bits will be described later.

As the conventional method, a controlled phase-flip gate of Duan et. al. will be described first (see L.-M. Duan, B. Wang, and H. J. Kimble, Phys. Rev. A 72, 032333 [2005]).

As shown in FIG. 3, a system in which two physical systems each having two lower states |0> and |1> and an upper state |2> are laid out in an optical resonator will be examined. |0> and |1> are used as a quantum bit. Assume that a |0>−|2> transition is strongly coupled to a resonator mode, and a |1>−|2> transition is not coupled to the resonator mode due to a large detuning frequency. A single-photon pulse that resonates with a resonator is externally input. Note that the resonator includes a total reflection mirror as one mirror and a partial transmission mirror as the other one, and the single-photon pulse is incident on the partial transmission mirror. This single-photon pulse may be substituted by a weak coherent light pulse, but only the case of a single-photon pulse will be examined for the sake of simplicity. Assume that the coupling constant between the physical systems and resonator is larger than the decay rate of the resonator and the relaxation rate of the physical systems, and the spectrum of the single-photon pulse is narrower than the coupling constant. At this time, if either one of the two physical systems is in the state |0>, the single-photon pulse is reflected without resonating with the resonator by an effect of vacuum Rabi splitting. On the other hand, if both the two physical systems are in the state |1>, the single-photon pulse is reflected after it resonates with the resonator. As a result, only in a state |1>|1> when both the physical systems are in the state |1>, the phase of the state of a photon shifts, and the states of all the systems change as follows:

(a₀₀|0 [symbol] |0 [symbol] +a₀₁|0 [symbol] |1 [symbol] +a₁₀|1 [symbol] |0 [symbol] +a₁₁|1 [symbol] |1 [symbol] |1 [symbol] →a₀₀|0 [symbol] |0 [symbol] |1 [symbol] +a₀₁|0 [symbol] |1 [symbol] |1 [symbol] +a₁₀|1 [symbol] |0 [symbol] |1 [symbol] +a₁₁|1 [symbol] |1 [symbol] (−|1 [symbol] =(a₀₀|0 [symbol] |0 [symbol] +a₀₁|0 [symbol] |1 [symbol] +a₁₀|1 [symbol] |0 [symbol] −a₁₁|1 [symbol] |1 [symbol] |1

[symbol]

Note that the first two ket vectors represent the states of the physical systems, and the third ket vector represents the state of a photon. As can be seen from the states of the physical systems, the controlled phase-flip gate can be executed in this way.

The controlled phase-shift gate of this embodiment will be described below. In this embodiment, a case will be examined wherein a system in which two physical systems each having three lower states |0>, |1>, and |3> and an upper state |2> are laid out in an optical resonator, as shown in FIG. 4. In FIG. 4, Δ₂₃ represents a detuning frequency between light that couples |3> and |2>, and the transition frequency of a |3>−|2> transition. Ω₂₃ represents a Rabi frequency corresponding to the light that couples |3> and |2>. As in the conventional method, assume that |0> and |1> are used as a quantum bit, and a |0>−|2> transition is strongly coupled to the resonator mode. Also, assume that |1>−|2> and |3>−|2> transitions are not coupled to the resonator mode due to a large detuning frequency. Light that couples |3> and |2> of the two physical systems is directly radiated from an external source to the two physical systems at an appropriate intensity (Rabi frequency Ω₂₃) and an appropriate detuning frequency Δ₂₃. While the light is kept radiated, a single-photon pulse that resonates with the resonator is radiated from an external source. As in the aforementioned conventional method, the resonator includes a total reflection mirror as one mirror and a partial transmission mirror as the other one, and the single-photon pulse is incident on the partial transmission mirror. In this embodiment as well, this single-photon pulse may be substituted by a weak coherent light pulse, but only the case of a single-photon pulse will be examined for the sake of simplicity. The case of substitution by a weak coherent light pulse will be described later with reference to FIG. 8.

As in the aforementioned conventional method, assume that the coupling constant between the physical systems and resonator is larger than the decay rate of the resonator and the relaxation rate of the physical systems, and the spectrum of the single-photon pulse is narrower than the coupling constant. At this time, even when the two physical systems are in any of |0>|0>, |0>|1>, |1>|0>, and |1>|1>, the single-photon pulse is reflected after it resonates with the resonator. A phase shift that the photon undergoes at that time depends on the number of physical systems in the state |0> that resonates with the resonator. As a result, the states of all the systems change as follows:

(a₀₀|0 [symbol] |0 [symbol] +a₀₁|0 [symbol] |1 [symbol] +a₁₀|1 [symbol] |0 [symbol] +a₁₁|1 [symbol] |1 [symbol] )|1 [symbol] →a₀₀|0 [symbol] |0 [symbol] (−e^{1φ}^{₂}|1 [symbol] )+a₀₁|0 [symbol] |1 [symbol] (−e^{1φ}^{₁}|1 [symbol] )+a₁₀|1 [symbol] |0 [symbol] (−e^{1φ}^{₁}|1 [symbol] )+a₁₁|1 [symbol] |1 [symbol] (−|1 [symbol] ) =−e^{1φ}^{₂}(a₀₀|0 [symbol] |0 [symbol] +e^{1(φ}^{₁}^{-φ}^{₂}⁾a₀₁|0 [symbol] |1 [symbol] +e^{1(φ}^{₁}^{-φ}^{₂}⁾a₁₀|1 [symbol] |0 [symbol] +e^{-1φ}^{₂}a₁₁|1 [symbol] |1 [symbol] |1

[symbol]

Note that the first two ket vectors represent the states of the physical systems, and the third ket vector represents the state of a photon. Also, φₙ represents a phase shift when n physical systems are initially in the state |0>. In the quantum mechanics, since an overall phase factor is physically meaningless and is ignored, and the state of the photon is excluded, the state change of the physical systems can be expressed by:

a₀₀|0 [symbol] |0 [symbol] +a₀₁|0 [symbol] |1 [symbol] +a₁₀|1 [symbol] |0 [symbol] +a₁₁|1 [symbol] |1 [symbol] →a₀₀|0 [symbol] |0 [symbol] +e^{1(φ}^{₁}^{-φ}^{₂}⁾a₀₁|0 [symbol] |1 [symbol] +e^{1(φ}^{₁}^{-φ}^{₂}⁾a₁₀|1 [symbol] |0 [symbol] +e^{-1φ}^{₂}a₁₁|1 [symbol] |1

[symbol]

Finally, for respective quantum bits, by performing a one-quantum-bit gate:

|0 [symbol] →|0 [symbol] |1 [symbol] →e^{-1(φ}^{₁}^{-φ}^{₂}⁾|1

[symbol]

the final state is expressed by:

a₀₀|0 [symbol] |0 [symbol] +a₀₁|0 [symbol] |1 [symbol] +a₁₀|1 [symbol] |0 [symbol] +a₁₁|1 [symbol] |1 [symbol] →a₀₀|0 [symbol] |0 [symbol] +a₀₁|0 [symbol] |1 [symbol] +a₁₀|1 [symbol] |0 [symbol] +e^{1(φ}^{₂}^{-2φ}^{₁}⁾a₁₁|1 [symbol] |1

[symbol]

This is a controlled phase-shift gate with a phase shift θ=φ₂−2φ₁.

The phase shift θ=φ₂−2φ₁ depends on the intensity (Rabi frequency Ω₂₃) of the light that couples |3> and |2>, and the detuning frequency Δ₂₃, and can be adjusted using them. The Rabi frequency Ω₂₃ is in proportion to a route of the intensity of light (or to the “electric field amplitude of light”).

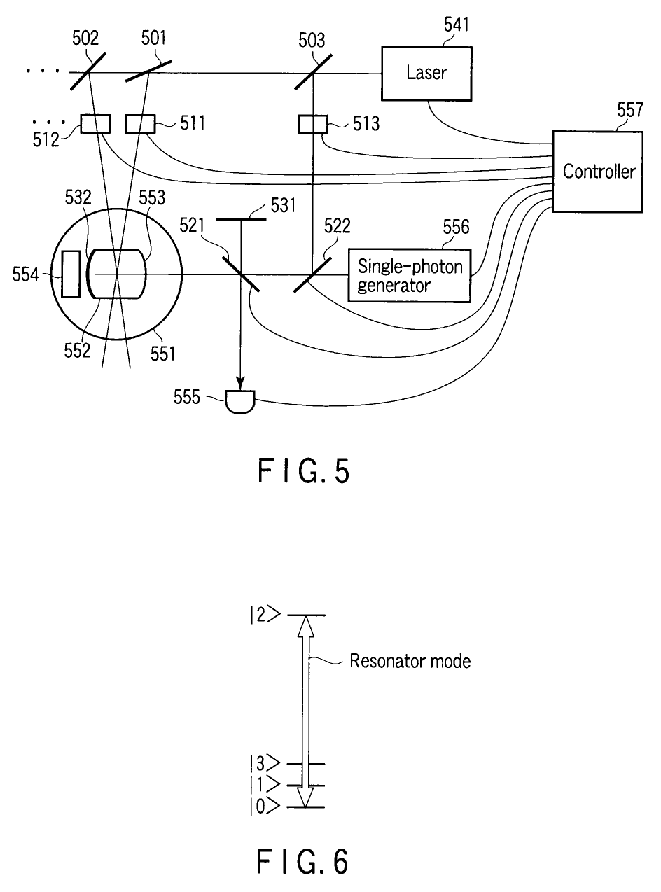

A quantum computer of this embodiment, which uses the physical systems shown FIG. 4, will be described below with reference to FIG. 5. FIG. 5 shows a quantum computer when physical systems can be surely distinguished from each other by positions in the physical systems shown in FIG. 4.

The quantum computer of this embodiment includes beam splitters 501, 502, and 503, acousto-optical modulators 511, 512, and 513, variable transmittance mirrors 521 and 522, total reflection mirrors 531 and 532, a dye laser 541, a cryostat 551, a crystal 552, a partial transmission mirror 553, a magnetic field generator 554, a photon detector 555, a single-photon generator 556, and a controller 557.

The beam splitters 501, 502, and 503 split light into transmitted light and reflected light or mix them, and guide the light to the next stage.

Based on the control signal from the controller 557, each of the acousto-optical modulators 511, 512, and 513 changes the frequency of incident light to a set frequency, changes the intensity of the incident light to a set intensity, and outputs the light of the changed frequency and intensity. The detuning frequency Δ₂₃ is adjusted by the acousto-optical modulators 511 and 512.

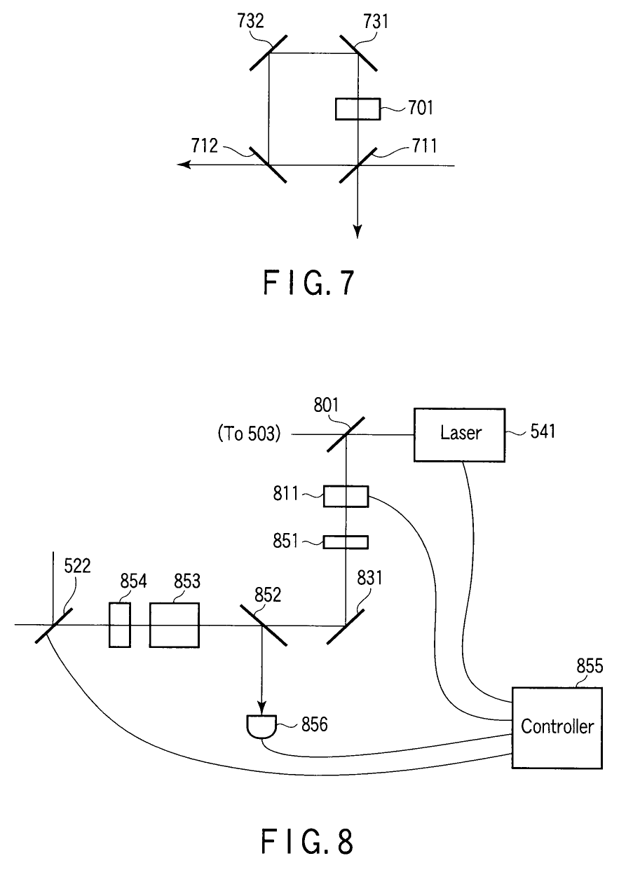

The variable transmittance mirrors 521 and 522 are special mirrors which can switch between high reflectance and high transmittance, and their transmittances are controlled by the controller 557. Each of the variable transmittance mirrors 521 and 522 can be implemented by a ring resonator shown in, e.g., FIG. 7. By adjusting the phase of a phase adjuster 701, the transmittance can be changed. In FIG. 7, reference numerals 731 and 732 denote total reflection mirrors; and 711 and 712, partial transmission mirrors.

The dye laser 541 is used as a light source, and its frequency is stabilized. Light output from the dye laser 541 is split by the beam splitters 501, 502, and 503, and the frequencies of the split light components are appropriately set via the acousto-optical modulators 511, 512, and 513.

The cryostat 551 is used to keep its interior at an ultralow temperature, and keeps it at 4K as a liquid helium temperature. The entire crystal 552 is placed inside the cryostat 551, and is kept at the liquid helium temperature of 4K.

The crystal 552 is, for example, Pr³⁺:Y₂SiO₅, the surface of which is mirror-polished, and is included in an optical resonator. The crystal 552 is the Pr³⁺:Y₂SiO₅ crystal. However, the present invention is not limited to the crystal as long as a material can provide the operations and effects of this embodiment. The total reflection mirror 532 and partial transmission mirror 553 are also components of the optical resonator. For example, Pr³⁺ ions doped in the Y₂SiO₅ crystal are used as the physical systems.

The magnetic field generator 554 generates a magnetic field and applies the magnetic field to the crystal 552 to split the degeneracy of an energy state. In this embodiment, the magnetic field generator 554 always generates a magnetic field of constant strength.

The photon detector 555 detects whether or not a photon has been received. The photon detector 555 detects a photon emitted from the optical resonator with high sensitivity and high efficiency.

The single-photon generator 556 generates a single-photon that resonates with the optical resonator.

The magnetic field generator 554 applies a magnetic field to the crystal 552 to cause Zeeman splitting in advance. Assume that the states |0>, |1>, and |3> shown in FIG. 5 are three out of six Zeeman-split hyperfine levels (see FIG. 6). Also, assume that the |0>−|2> transition uses ions which just resonate with the resonator mode, and |0> and |1> of these ions are used as a quantum bit.

Initialization processes will be described below.

The controller 557 sets the variable transmittance mirror 521 to be 100% transmittance, and the variable transmittance mirror 522 to be 100% reflectance, and controls the dye laser 541 to irradiate the resonator with light that resonates with the resonator. After that, the controller 557 irradiates, from the side surface, the central position of the resonator mode in the crystal 552 with light beams of frequencies equal to the transition frequencies between |2> and all ground states other than |0> of ions whose |0>−|2> transition frequency equals the resonance frequency of the resonator, for a while (optical pumping), thereby transiting the states of ions to |0> which are located at that position and have the |0>−|2> transition frequency equal to the resonance frequency of the resonator. In this way, ions which are located at the position of the resonator mode of the crystal center and whose |0>−|2> transition resonates with the resonator can be initialized to |0>. |0> and |1> of these ions are used as a quantum bit.

Light that couples |3> and |2> upon execution of the controlled phase-shift gate of this embodiment is radiated from the dye laser 541 to ions in the crystal. The detuning frequency Δ₂₃ is adjusted by the acousto-optical modulators 511 and 512.

A single-photon pulse that resonates with the resonator upon execution of the controlled phase-shift gate of this embodiment is supplied from the single-photon generator 556. At this time, the variable transmittance mirrors 521 and 522 are set to have a 100% transmittance. In order to execute the controlled phase-shift gate of this embodiment, the single-photon generator 556 applies the single-photon pulse to the resonator while the dye laser 541 applies the light that couples |3> and |2> to ions in the crystal. To attain this operation, the controller 557 is used.

The single-photon generator 556 and photon detector 555 can be used to read a quantum bit. A certain quantum bit is read as follows. The variable transmittance mirror 521 is set to exhibit 50% transmittance, the variable transmittance mirror 522 is set to exhibit 100% transmittance, and the single-photon generator 556 applies a single-photon pulse to the resonator. Note that the position of the total reflection mirror 531 is set to guide the single-photon pulse toward the photon detector 555 100% when that single-photon pulse resonates with the resonator and is reflected. The photon detector 555 detects the photon reflected by the resonator. This is an example of a Michelson interferometer. If the state of a quantum bit is |1>, the photon resonates with the resonator and is guided 100% to the photon detector 555, thus detecting the photon. By contrast, if the state of a quantum bit is |0>, the photon does not resonate with the resonator due to vacuum Rabi splitting, and has a 180° phase shift compared to the case in which it resonates. Hence, the photon returns 100% to the single-photon generator 556, and is not detected by the photon detector 555. In this manner, a quantum bit can be read.

A quantum computer shown in FIG. 5, which uses the dye laser 541 in place of the single-photon generator 556 will be described below with reference to FIG. 8.

The quantum computer includes, in place of the single-photon generator 556, a beam splitter 801, polarizing beam splitter 852, acousto-optical modulator 811, ND filter 851, total reflection mirror 831, Faraday rotator 853, quarter-wavelength plate 854, controller 855, and light detector 856. The polarizing beam splitter 852 reflects the vertically polarized component of incident light from a light source, and transmits the horizontally polarized component.

The beam splitter 801 is arranged between the dye laser 541 and beam splitter 503 shown in FIG. 5, and the apparatus components shown in FIG. 8 are arranged, so that light output from the quarter-wavelength plate 854 via the Faraday rotator 853 in FIG. 8 is input to the variable transmittance mirror 522 in FIG. 5. The controller 855 monitors detection of a photon by the light detector 856, and controls the dye laser 541 and acousto-optical modulator 811. Assume that the polarization of light which is reflected by the total reflection mirror 831 and becomes incident on the polarizing beam splitter 852 is that (horizontal polarization) which is transmitted through the polarizing beam splitter 852.

A laser output from the dye laser 541 is reflected by the beam splitter 801, and undergoes adjustment of its light frequency and light intensity by the acousto-optical modulator 811. After that, the light is weakened by the ND filter 851, and is input to the variable transmittance mirror 522 via the total reflection mirror 831, beam splitter 852, Faraday rotator 853, and quarter-wavelength plate 854. The light detector 856 receives a photon of reflected light which comes from the optical resonator (partial transmission mirror 553 and total reflection mirror 532) including the crystal 552 and is reflected by the polarizing beam splitter 852. The controller 855 monitors a photon received by the light detector 856. When the controller 855 controls the acousto-optical modulator 811 to stop irradiation to the optical resonator at the instance of counting one photon, this is equivalent to input of one photon to the optical resonator, i.e., the same operation can be attained as in a case in which the apparatus shown in FIG. 8 implements the single-photon generator 556.

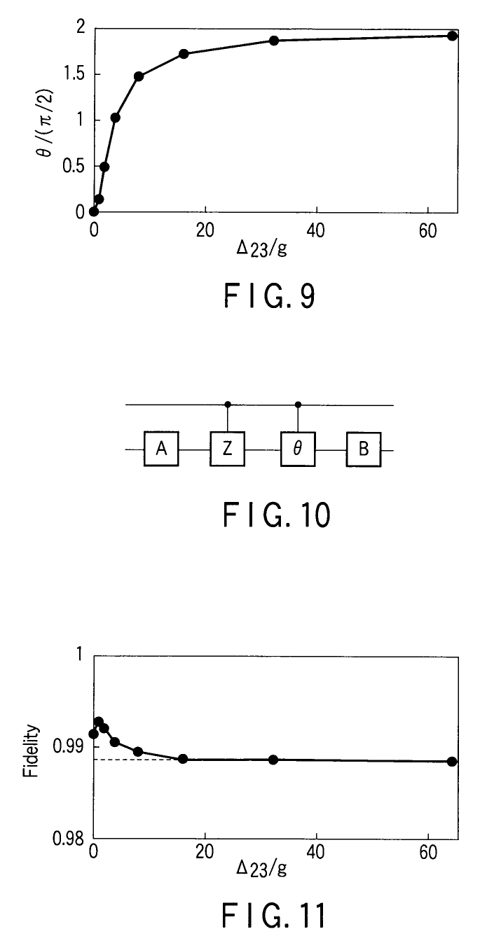

The calculation result when the apparatus shown in FIG. 5 uses the crystal shown in FIG. 4 will be described below with reference to FIG. 9. In FIG. 9, g is the coupling constant between the |0>−|2> transition and resonator mode, and Δ₂₃ is the detuning frequency between the light that couples |3> and |2> and the transition frequency of the |3>−|2> transition.

Note that parameter values are set as follows. Letting g be the coupling constant, Ω₂₃=0.3 g, a decay rate κ=4 g of the resonator with respect to the transmittance of an input mirror of the resonator, a decay rate γ_{C}=0.1 g of the resonator due to losses other than the transmittance of the input mirror of the resonator, a relaxation rate γₐ=0.01 g of the upper state |2> of an atom, and a pulse width T₀=40 g⁻¹ of a single-photon pulse (the envelope of a pulse strength is given by:

e^{-2t}^{²}^{/T}^{₀}^{²}).

In order to attain a phase shift close to π, a very large detuning frequency is required and is not so practical. In such case, a phase shift 1/2 of the phase to be shifted may be done twice. In addition, in order to attain a phase shift close to π, a conventional controlled phase-flip gate may be executed, and the controlled phase-shift gate may be executed immediately after the controlled phase-flip gate, as shown in FIG. 10. In this case, the error probability is nearly equal to that when the conventional controlled phase-flip gate is used. Also, in order to attain a phase shift just by π, the conventional controlled phase-flip gate may be executed without inputting the light that couples |3> and |2>.

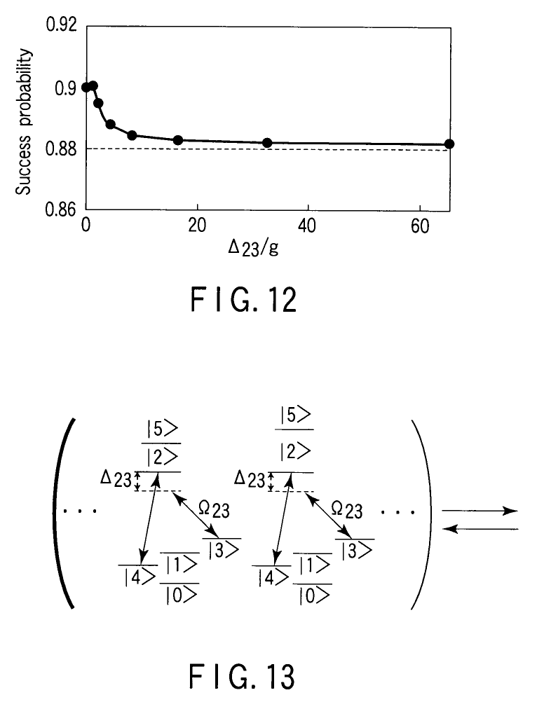

The calculation results for confirming if the error probability does not rise compared to the controlled phase-flip gate of Duan et. al. will be described below with reference to FIGS. 11 and 12. In FIGS. 11 and 12, g is the coupling constant between the |0>−|2> transition and the resonator mode, and Δ₂₃ is the detuning frequency between the light that couples |3> and |2> and the transition frequency of the |3>−|2> transition.

Using the aforementioned parameters, the fidelities and success probabilities of the controlled phase-shift gate of this embodiment and the controlled phase-flip gate of Duan et. al. are calculated for four initial states |0>|0>, |0>|1>, |1>|0>, and |1>|1>, and averages of these calculation results are calculated. FIGS. 11 and 12 show these results. Black dots indicate the results of the controlled phase-shift gate of the present invention, and dotted lines indicate the results of the controlled phase-flip gate of Duan et. al. (since the method of Duan et. al. does not use light that couples |3> and |2>, Δ₂₃ has no significance, and a constant value is obtained for Δ₂₃). Note that the success probability is a probability that a quantum jump never occurs in a quantum jump approach or quantum trajectory approach (see M. B. Plenio and P. L. Knight, Rev. Mod. Phys. 70, 101 [1998]). A fidelity f is defined by f=<Ψ_{f}|ρ_{f}|Ψ_{f}> using a density operator ρ_{f} of a final state when the gate operation has succeeded (when no quantum jump occurs), and an ideal gate output |Ψ_{f}>. As can be seen from the results shown in FIGS. 11 and 12, the controlled phase-shift gate of this embodiment is not inferior to the controlled phase-flip gate of Duan et. al, and has higher performance.

A method of performing a gate operation for a specific quantum bit when there are three or more quantum bits will be described below with reference to FIG. 13. FIG. 13 shows a system used in the method of this embodiment, which allows to independently operate quantum bits based on different frequencies of light to be irradiated. In FIG. 13, Δ₂₃ represents the detuning frequency between the light that couples |3> and |2> and the transition frequency of the |3>−|2> transition. Also, Ω₂₃ represents the Rabi frequency corresponding to the light that couples |3> and |2>. As shown in FIG. 13, lower levels include |4> in addition to |0>, |1>, and |3>, and upper states include |5> in addition to |2>. Assume that a quantum bit is expressed by |0> and |1>. Also, assume that a |4>−|2> transition is coupled to the resonator mode in this case. Furthermore, assume that the transition frequencies of |5> and respective lower states are sufficiently different for respective physical systems. A one-quantum-bit gate for a certain specific quantum bit can be executed using lasers that resonate with |0>−|5>, |1>−|5>, and |3>−|5> transitions (for a detailed method, see Z. Kis and F. Renzoni, Phys. Rev. A 65, 032318 (2002), and L.-M. Duan, J. I. Cirac, and P. Zoller, Science 292, 1695 [2001]) . Since these lasers are sufficiently off-resonant with the transitions of other physical systems, other quantum bits do not change. In order to execute the controlled phase-shift gate for two specific quantum bits, |0> of these two physical systems is changed to |4>. To attain this change, adiabatic passage using lasers that resonate with |0>−|5> and |4>−|5> transitions can be executed (see K. Bergmann, H. Theuer, B. W. Shore, Rev. Mod. Phys. 70, 1003 [1998]). After that, when the controlled phase-shift gate is executed considering |4> as |0> in the above description of the controlled phase-shift gate, and |4> is returned to |0> by adiabatic passage using lasers which resonate with |0>−|5> and |4>−|5> transitions, the controlled phase-shift gate can be executed for these two quantum bits. Since all light beams used during these operations are sufficiently off-resonant with other physical systems, other physical systems do not change.

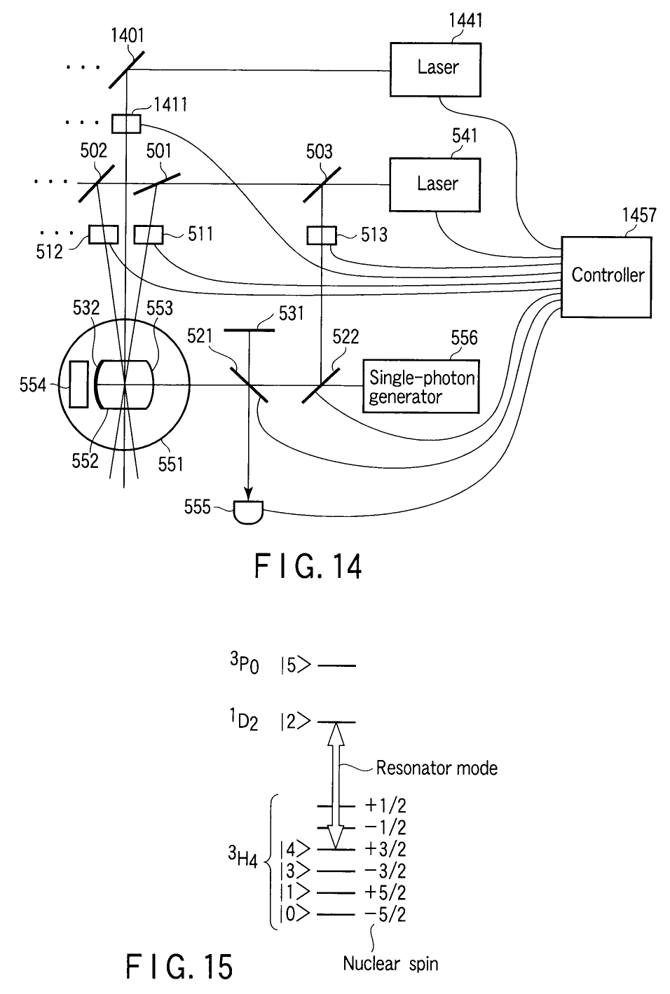

A quantum computer of this embodiment, which uses physical systems corresponding to FIG. 13, will be described below with reference to FIG. 14.

The quantum computer shown in FIG. 14 newly includes a beam splitter 1401, acousto-optical modulator 1411, and dye laser 1441 in addition to the apparatus components of the quantum computer shown in FIG. 5. A controller 1457 replaces the controller 557. The controller 1457 also controls the acousto-optical modulator 1411.

The functions of the beam splitter 1401, acousto-optical modulator 1411, and dye laser 1411 are the same as those of the beam splitters (501, 502, and 503), acousto-optical modulators (511, 512, and 512, and dye laser 541.

The magnetic field generator 554 applies a magnetic field to the crystal 552 to cause Zeeman splitting in advance. As shown in FIG. 15, the states |0>, |1>, |3>, and |4> shown in FIG. 13 are defined as four hyperfine levels of ground states ³H₄ of Pr³⁺ ions, and the state |2> shown in FIG. 13 is defined as one hyperfine level of excited states ¹D₂. Also, another excited state |5> required to individually operate respective quantum bits is extracted from one hyperfine level of excited states ³P₀. As in FIG. 5, an optical resonator is configured by mirror-polishing the crystal surface. Of the Pr³⁺ ions, ions whose |4>−|2> transition just resonates with the resonator mode are used, and |0> and |1> of these ions are used as a quantum bit.

Initialization processes will be described below.

The controller 1457 sets the variable transmittance mirror 521 to be 100% transmittance, and the variable transmittance mirror 522 to be 100% reflectance, and controls the dye laser 541 to irradiate the resonator with light that resonates with the resonator. After that, the controller 1457 irradiates, from the side surface, the central position of the resonator mode in the crystal 552 with light beams of frequencies equal to the transition frequencies between |2> and all ground states other than |0> of ions whose |4>−|2> transition frequency equals the resonance frequency of the resonator, for a while (optical pumping), thereby transiting the states of ions to |0> which are located at that position and have the |4>−|2> transition frequency equal to the resonance frequency of the resonator. In this way, ions which are located at the position of the resonator mode of the crystal center and whose |4>−|2> transition frequency resonates with the resonator can be initialized to |0>. |0> and |1> of these ions are used as a quantum bit.

Due to inhomogeneous broadening of the excited states ³P₀, if the ion concentration is sufficiently small (or if frequencies used are sufficiently separated from the center of the inhomogeneous broadening), the transition frequencies between |0> and |5>, |1> and |5>, |3> and |5>, and |4> and |5> are largely different between different ions, and light beams which resonate with transitions between |0> and |5>, |1> and |5>, |3> and |5>, and |4> and |5> of a certain ion are sufficiently off-resonant with all optical transitions of other ions. In this way, using the light beams that resonate with transitions between |0> and |5>, |1> and |5>, |3> and |5>, and |4> and |5>, individual ions can be operated in distinction from each other.

The dye laser 541 irradiates ions in the crystal with light that couples |3> and |2> upon execution of the controlled phase-shift gate of this embodiment. The detuning frequency Δ₂₃ is adjusted by the acousto-optical modulators 511 and 512. The dye laser 1411 irradiates ions in the crystal with light beams which resonate with the |0>−|5>, |1>−|5>, |3>−|5>, and |4>−|5> transitions required to individually operate ions.

A single-photon pulse that resonates with the resonator upon execution of the controlled phase-shift gate of this embodiment is supplied from the single-photon generator 556. At this time, the variable transmittance mirrors 521 and 522 are set to have a 100% transmittance. In order to execute the controlled phase-shift gate of this embodiment, the single-photon generator 556 applies the single-photon pulse to the resonator while the dye laser 541 applies the light that couples |3> and |2> to ions in the crystal. To attain this operation, the controller 1457 is used.

The single-photon generator 556 and photon detector 555 can be used to read a quantum bit. A certain quantum bit is read as follows. The dye laser 1411 provides light beams which resonate with |0>−|5> and |4>−|5> transitions of a corresponding ion, and adiabatic passage changes |0> of that ion to |4>. Then, the variable transmittance mirror 521 is set to exhibit 50% transmittance, the variable transmittance mirror 522 is set to exhibit 100% transmittance, and the single-photon generator 556 applies a single-photon pulse to the resonator. Note that the position of the total reflection mirror 531 is set to guide the single-photon pulse toward the photon detector 555 100% when that single-photon pulse resonates with the resonator and is reflected. The photon detector 555 detects the photon reflected by the resonator. This is an example of a Michelson interferometer. If the state of a quantum bit is |1>, the photon resonates with the resonator and is guided 100% to the photon detector 555, thus detecting the photon. By contrast, if the state of a quantum bit is |0>, the photon does not resonate with the resonator due to vacuum Rabi splitting, and has a 180° phase shift compared to the case in which it resonates. Hence, the photon returns 100% to the single-photon generator 556, and is not detected by the photon detector 555. In this manner, a quantum bit can be read.

According to the aforementioned embodiment, compared to a case in which only a controlled phase-flip gate is performed by externally inputting a photon to an optical resonator which includes a plurality of physical system, a controlled unitary gate can be executed at a lower error probability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A quantum computer comprising:
an optical resonator configured to have a resonance frequency;
a plurality of physical systems, which are included in the optical resonator, configured to have at least four energy states, and in which letting |0>, |1>, |3>, and |2> be the four energy states, an energy of |2> is higher than energies of |0>, |1>, and |3>, a transition frequency of a |0>−|2> transition is equal to the resonance frequency, and |0> and |1> express a quantum bit;
a first light source configured to emit first light that resonates with the optical resonator;
a second light source configured to irradiate a plurality of specific physical systems of the physical systems with second light that couples |3> and |2>;
a light detector configured to detect a photon emitted from the optical resonator; and
a controller configured to control the first light source to irradiate the optical resonator with the first light and control the light detector to perform light detection during irradiation of the second light to the specific physical systems.

2. The computer according to claim 1, wherein the physical systems are rare-earth ions doped in a crystal.

3. The computer according to claim 1, wherein the first light source is a photon source which generates a single-photon.

4. The computer according to claim 1, wherein the first light source comprises:
an irradiation unit configured to irradiate the optical resonator with the second light;
a detection unit configured to detect a reflected photon from the optical resonator; and
a stop unit configured to stop irradiation of the second light at an instance when the detection unit detects one photon.

5. A quantum computer comprising:
an optical resonator configured to have a resonance frequency;
a plurality of physical systems, which are included in the optical resonator, configured to have at least six energy states, and in which letting |0>, |1>, |3>, |4>, |2>, and |5> be the six energy states, energies of |2> and |5> are higher than energies of |0>, |1>, |3>, and |4>, a transition frequency of a |4>−|2> transition is equal to the resonance frequency, light beams which resonate with |0>−|5>, |1>−|5>, |3>−|5>, and |4>−|5> transitions of respective physical systems do not resonate with all optical transitions of other physical systems, and |0> and |1> express a quantum bit;
a first light source configured to emit first light that resonates with the optical resonator;
a second light source configured to irradiate the physical systems with second light that couples |3> and |2>;
a third light source configured to irradiate respective physical systems with third light that nearly resonates with the |0>−|5>, |1>−|5>, |3>−|5>, and |4>−|5> transitions;
a light detector configured to detect a photon emitted from the optical resonator; and
a controller configured to select a physical system as a target of the third light source, and to allow irradiation of the first light and light detection by the light detector during irradiation of the second light.

6. The computer according to claim 5, wherein the physical systems are rare-earth ions doped in a crystal.

7. The computer according to claim 5, wherein the first light source is a photon source which generates a single-photon.

8. The computer according to claim 5, wherein the first light source comprises:
an irradiation unit configured to irradiate the optical resonator with the second light;
a detection unit configured to detect a reflected photon from the optical resonator; and
a stop unit configured to stop irradiation of the second light at an instance when the detection unit detects one photon.

9. A quantum computation method using the quantum computer according to claim 1, comprising:
executing a controlled phase-shift gate to quantum bits of two out of the physical systems by radiating the first light while the second light source irradiates the two physical systems with the second light.

10. A quantum computation method using the quantum computer according to claim 5, comprising:
changing |0> to |4> by radiating from the third light source light beams which resonate with |0>−|5> and |4>−|5> transitions of two out of the physical systems;
radiating light that resonates with the optical resonator from the first light source while the second light source radiates the second light that couples |3> and |2> of the two physical systems; and
executing a controlled phase-shift gate to quantum bits of the two physical systems by returning |4> to |0> by radiating the light beams which resonate with the |0>−|5> and |4>−|5> transitions from the third light source.
